(19) United States
(12) Patent Application Publication
(10) Pub. No.: US 2010/0057874 A1
(43) Pub. Date: Mar. 4, 2010

(54) Preventing wrongful transmission of message content

(75) Inventor: Ram Cohen, Tel Aviv (IL)

Correspondence Address: ROBERT G. LEV, 4766 MICHIGAN BLVD., YOUNGSTOWN, OH, 44505, US

(73) Assignee: PostalGuard Ltd., Petah Tikva (IL)

(21) Appl. No.: 12/583,825

(22) Filed: Aug. 25, 2009

Related U.S. Application Data
(60) Provisional application No. 61/091,745, filed on Aug. 26, 2008.

(51) Int. Cl. G06F 15/16

(52) U.S. Cl. 709/206

(57) ABSTRACT

A method of restricting transmission of a message (step A) to an addressee unless said message contains previously specified data associated with the addressee, in which case the message is transmitted (STEP B) to the addressee.

### PRIORITY INFORMATION

The present invention claims priority to U.S. Provisional Application No. 61/091,745 filed on Aug. 26, 2008, making reference thereto in its entirety.

### FIELD OF THE INVENTION

The present invention is directed to a means and method for preventing wrongful transmission of confidential data by email, SMS, instant messaging or similar electronic messaging systems.

### BACKGROUND

In the modern world, electronic messaging, such as emails, SMS and instant messaging (IM) communications are increasingly used for transmitting data. The messages are sent to specific recipients. They may, however, go astray if the email address or personal phone number of the intended recipient is mistyped. One common problem is where the wrong recipient is selected from the address book of the sender. In such instances, the message is generally sent to a real addressee that is known to the sender, instead of to the intended recipient. This is analogous to muddling the envelopes and sending the wrong letter, bill or invoice to a known but wrong contact by conventional (snail) mail. Personal and perhaps embarrassing information may be sent to the wrong person, thereby compromising confidentiality of the intended recipient and may also lead to financial losses and liability issues. Not only does the wrong contact receive information he/she shouldn't have received, but also the sender is unaware of the mistake.

The inadvertent transmission of personal and confidential information to the wrong recipient may have unwelcome ramifications. There is a need to restrict transmission of personal and confidential information to the correct recipients and the present invention addresses this need.

### SUMMARY OF THE INVENTION

An aspect of the present invention is directed to providing a method of restricting transmission of a message to an addressee unless the message contains previously specified data associated with the addressee and selectable from a database of recipient—data records, in which case the message is transmitted to the addressee.

Furthermore, generally the message may be actively sent after the sender affirms that the addressee is correct or takes other appropriate action.

Optionally, the message is an email

Alternatively, the message is a Short Message Service message SMS or an instant message (IM)

Optionally, the previously specified data is included in at least one of the group consisting of message subject line, message body text, names of attachments, contents of attachments or a header of the message.

Typically, the database is selected from the list of sender-specific databases and centralized databases serving a plurality of senders.

Optionally, the associated data includes at least a string of characters of a critical length forming a part of at least one of the list consisting of social security number, personal identification number, bank account number, passport number, phone number, first name, middle name, family name and/or credit card number.

Preferably the restricting is not applied to a list of addressees considered non-sensitive.

Optionally, the list of non-sensitive addressees are characterized by having email addresses with domain names selected from a predefined list of non-sensitive domains.

Alternatively, the predefined list of non-sensitive domain names includes the domain of the sender.

In some configurations, the predefined list of non-sensitive domain names excludes the domain of the sender.

In other configurations, the predefined list of non-sensitive domain names includes the domain of the sender.

Optionally, the restricting is only applied to a list of addressees considered sensitive.

Optionally, the restricting is only applied if the message contains certain elements in its contents (such as specific text in the subject, body or attachments).

In some configurations, the list of sensitive addressees contains addresses having email addresses with domain names selected from a predefined list of sensitive domains.

Typically, the predefined list of sensitive domain names includes the domain of the sender.

In an alternative configuration, the predefined list of sensitive domain names excludes the domain of the sender.

Typically, restricting transmission involves at least one of the group consisting of:

a. Deleting the message
b. Notifying sender that transmission was interrupted
c. Sending the message back to the sender, optionally after modification
d. Detailing nature of reason for restricting transmission
e. Adding a log event
f. Notifying a predetermined third party that transmission was restricted.
g. Suspending message transmission until recipients are confirmed

Optionally, the sender is able to over-ride the transmission restriction to transmit the message.

Typically the message is controlled by an entity selected from the list of application plug-ins, add-on, sender clients, proxy servers, mail gateways and routers.

A second aspect of the invention is directed to a system for implementing a method restricting transmission of a message to an addressee unless the message contains previously specified data associated with the addressee and selectable from a database of addressee—data records, in which case the message is transmitted.

A third aspect of the invention is directed to a software module for providing to a communication program for implementing a method for restricting transmission of a message to an addressee unless the message contains previously specified data associated with the addressee and selectable from a database of addressee—data records, in which case the message is transmitted.

### BRIEF DESCRIPTION OF FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1 is a flowchart illustrating a method of the present invention;

FIG. 2 is conceptual block diagram of an email scenario for illustrating the method of claim 1, and

FIG. 3 is an annotated illustration of an email message showing possible parts thereof.

### DESCRIPTION OF PREFERRED EMBODIMENTS

The present invention relates to methods of preventing sensitive data from being sent to the wrong addressee due to misaddressing messages, such as by selecting the wrong contact from an address book, for example.

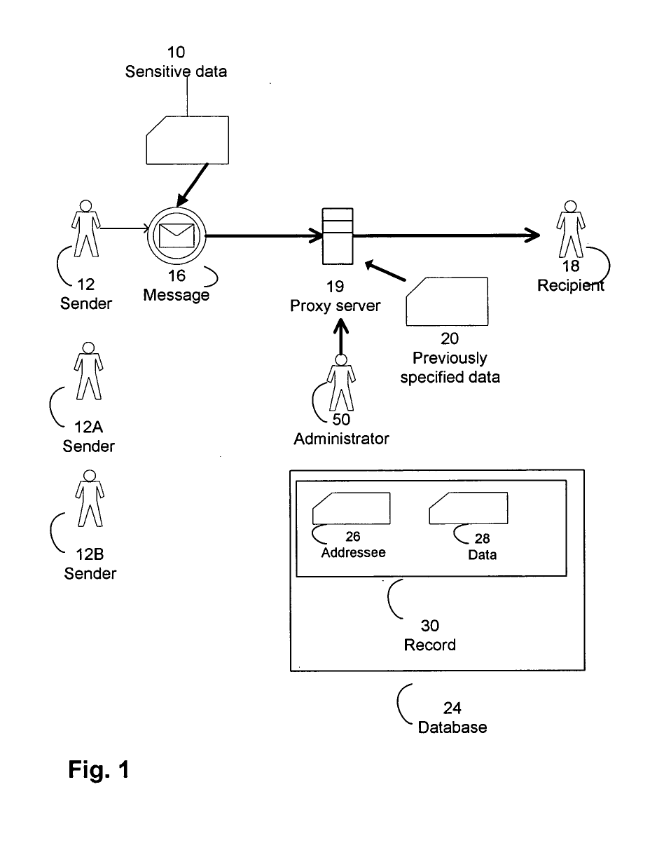

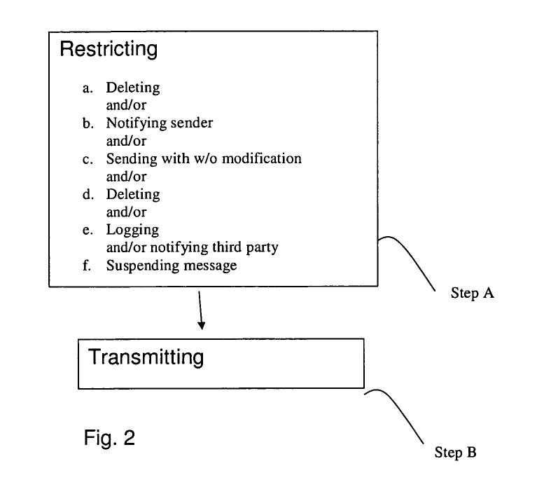

With reference to FIGS. 1 and 2, a method of restricting sensitive data 10 from being sent by a sender 12 to a wrong recipient is presented, in which transmission of a message 16 to an addressee 18 is prevented unless the message 16 contains previously specified data 20 associated with the addressee 18 and selectable from a database 24 of addressee 26—previously specified data 28 records 30.

By way of illustration, the message 16 is depicted in FIG. 1 as being an email. However, it will be appreciated that in some embodiments of the invention, other types of message such as Short Message Service messages (SMS) or instant messages (IM) are contemplated.

By way of illustration, the test whether the message 16 contains a previously specified data 20 associated with the addressee 18 is depicted in FIG. 1 as done by a proxy server 19 which intercepts communication between the sender 12 and the recipient 18.

In addition to proxy servers, it will be appreciated that the testing may be performed by other components such as, inter alia, a plug-in or add-on, by a sender client, a mail gateway or router.

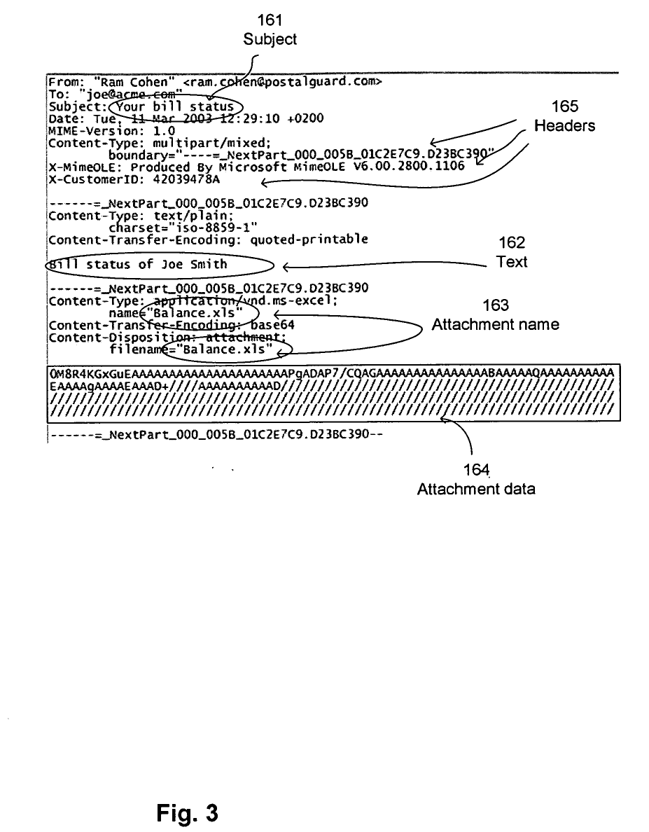

Optionally, the previously specified associated data 20 is included in at least one of the group consisting of message subject line 161, message body text 162, names of attachments 163, contents of attachments 164, or any header of the message 165 such as headers as described by RFC-822 as depicted in FIG. 3.

Typically, the database 24 is sender 12 specific. It may, however, be a centralized database serving a plurality of senders 12, 12A, 12B.

The previously associated specified associated data 20 is tabulated as at least part of a record 30 in a database 24. It need not, however, be a full corresponding data record 30 for the sender 12, but may be part of the record having at least a critical size, such as at least a string of characters of a critical length forming a part of, say, the social security number, personal identification number, bank account number, passport number, phone number, first name, middle name, family name and/or credit card number of the intended addressee 18.

Preferably the step of restricting STEP A is not applied to some addressees considered non-sensitive, such as, inter alia, addressees have email addresses with domain names selected from a predefined list of non-sensitive domains, perhaps including the domain of the sender, for example. In some configurations however, the predefined list of non-sensitive domain names will intentionally actively exclude the domain of the sender, treating this as sensitive.

Embodiments of the invention may be configured such that the restricting is only applied to a list of addressees considered sensitive, such as addressees having email addresses with domain names selected from a predefined list of sensitive domains.

The step of restricting transmission (step A) may include one or more of the following sub-steps:

a. Deleting the message 16
b. Notifying sender 12 that transmission (step A) was interrupted
c. Sending the message 16 back to the sender 12, optionally after modification
d. Detailing reason for restricting transmission
e. Adding a log event
f. Notifying a predetermined third party that transmission was restricted.
g. Suspending message transmission until recipients are confirmed

In some embodiments, the sender 12 is able to over-ride transmission restriction (step A) to transmit (step B) the message 16. In other embodiments, a third party, such as an administrator 50, may control the system in parallel to the sender 12. The system may be controlled at any of a number of levels of the communication hierarchy, for example by the sender client application, by a proxy server, by the mail gateway or by a router. It will typically be automated, but may include manual over-rides and the invention relates to the method, the system and to software implementations thereof.

In general, once the problem resulting in the restriction is overcome or the sender 12 or third party (postmaster) 50 over-rides the restriction, the message 16 is transmitted (step B). Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1. A method of restricting transmission of a message (step A) to an addressee unless said message contains previously specified data associated with the addressee, in which case the message is transmitted to the addressee.

2. The method of claim 1, wherein the message is an email

3. The method of claim 1 wherein the message is an SMS

4. The method of claim 1 wherein the message is an instant message (IM)

5. The method of claim 1, wherein the previously specified data is included in at least one of the group consisting of message subject line, message body text, names of attachments, contents of attachments, any textual field (header) of the message.

6. The method of claim 1 wherein the database is selected from the list of sender specific database and centralized database serving a plurality of senders.

7. The method of claim 1 wherein the associated data includes at least a string of characters of a critical length forming a part of at least one of the list consisting of social security number, personal identification number, bank account number, passport number, phone number, first name, middle name, family name and/or credit card number.

8. The method of claim 2 wherein the restricting is not applied to a list of addressees considered non-sensitive.

9. The method of claim 8 wherein the list of non-sensitive addressees have email addresses with domain names selected from a predefined list of non-sensitive domains.

10. The method of claim 8 wherein the predefined list of non-sensitive domain names includes the domain of the sender.

11. The method of claim 8 wherein the predefined list of non-sensitive domain names excludes the domain of the sender.

12. The method of claim 2 wherein the restricting is only applied to a list of addressees considered sensitive.

13. The method of claim 12 wherein the list of sensitive addressees have email addresses with domain names selected from a predefined list of sensitive domains.

14. The method of claim 12 wherein the predefined list of sensitive domain names includes the domain of the sender.

15. The method of claim 12 wherein the predefined list of sensitive domain names excludes the domain of the sender.

16. The method of claim 1 wherein the restricting transmission involves at least one of the group consisting of:
a. Deleting the message
b. Notifying sender that transmission was interrupted
c. Sending the message back to the sender, optionally after modification
d. Detailing nature of reason for restricting transmission
e. Adding a log event
f. Notifying a predetermined third party that transmission was restricted.
g. Suspending message transmission until recipients are confirmed

17. The method of claim 16 wherein the sender is able to over-ride transmission restriction (Step A) to transmit (Step B) the message.

18. The method of claim 1 being controlled by an entity selected from the list of application plugin/add-on, sender client, proxy server, mail gateway and router.

19. A system for implementing the method of claim 1.

20. A software module for providing to a communication program for implementing the method of claim 1.
